(19) United States
(12) Patent Application Publication
(10) Pub. No.: US 2025/0375774 A1
(43) Pub. Date: Dec. 11, 2025

(54) EXHAUST GAS TREATMENT SYSTEM, DUST COLLECTION DEVICE AND CONTROL METHOD OF EXHAUST GAS TREATMENT SYSTEM

(71) Applicant: MITSUBISHI HEAVY INDUSTRIES, LTD., Tokyo (JP)

(72) Inventors: Shintaro Honjo, Tokyo (JP); Takashi Kamijo, Tokyo (JP); Satoru Sugita, Tokyo (JP); Tatsuya Tsujiuchi, Tokyo (JP); Hiromitsu Nagayasu, Tokyo (JP); Yasutoshi Ueda, Tokyo (JP)

(73) Assignee: MITSUBISHI HEAVY INDUSTRIES, LTD., Tokyo (JP)

(21) Appl. No.: 18/733,969

(22) Filed: Jun. 5, 2024

(51) Int. Cl. B03C 3/68; B01D 53/14; B01D 53/18; B03C 3/01; B03C 3/16

(52) U.S. Cl. CPC B03C 3/68; B01D 53/1425; B01D 53/1475; B01D 53/185; B03C 3/01; B03C 3/16; B01D 2257/504; B01D 2258/0283; B03C 2201/24; B03C 2201/30

(57) ABSTRACT

An exhaust gas treatment system includes a cooling tower in which exhaust gas including carbon dioxide is cooled, an absorption tower into which an absorption liquid capable of absorbing carbon dioxide in exhaust gas is introduced and in which the absorption liquid absorbs carbon dioxide in exhaust gas that has gone through the cooling tower, a regeneration tower in which the absorption liquid that has absorbed carbon dioxide is heated, carbon dioxide is separated from the absorption liquid, and the absorption liquid is regenerated, a wet-type electric dust collector in which suspended particulate matter including SO₃ included in exhaust gas is charged such that the suspended particulate matter is captured, a detection unit, and a control device. The control device includes a charge output adjustment unit which adjusts a charge output in the wet-type electric dust collector.

### TECHNICAL FIELD

The present disclosure relates to an exhaust gas treatment system, a dust collection device, and a control method of an exhaust gas treatment system.

### BACKGROUND ART

It is desirable that the discharge amount of carbon dioxide included in exhaust gas from ships and plants such as power plants be reduced. For this reason, for example, Patent Literature 1 discloses an exhaust gas treatment system that collects carbon dioxide included in exhaust gas. In this exhaust gas treatment system, carbon dioxide is collected by introducing exhaust gas into an absorption tower and bringing the exhaust gas into contact with an absorption liquid after sulfur oxides in the exhaust gas are removed. Moreover, in this exhaust gas treatment system, suspended particulate matter (mist-generating matter), which is included in exhaust gas and includes sulfur trioxide (SO₃) serving as a discharge source of mist that holds the absorption liquid inside the absorption tower and causes scattering to the outside of the system, is removed through charging by a wet-type electric dust collector.

### CITATION LIST

### Patent Literature

[Patent Literature 1] Japanese Patent No. 6045652

### SUMMARY OF INVENTION

### Technical Problem

However, in the exhaust gas treatment system described in Patent Literature 1, if charging in the wet-type electric dust collector becomes excessive, the amount of suspended particulate matter increases, which may adversely affect the performance of exhaust gas treatment.

The present disclosure has been made in order to resolve the foregoing problems, and an object thereof is to provide an exhaust gas treatment system, a dust collection device, and a control method of an exhaust gas treatment system, in which an adverse effect on the performance of exhaust gas treatment can be curbed.

### Solution to Problem

In order to resolve the foregoing problems, an exhaust gas treatment system according to the present disclosure includes a cooling tower in which a cooling liquid is brought into contact with exhaust gas including carbon dioxide such that the exhaust gas is cooled; an absorption tower into which an absorption liquid capable of absorbing carbon dioxide in the exhaust gas is introduced and in which the absorption liquid absorbs carbon dioxide in the exhaust gas that has gone through the cooling tower; a regeneration tower in which the absorption liquid that has absorbed carbon dioxide is heated, carbon dioxide is separated from the absorption liquid, and the absorption liquid is regenerated; a detection unit which detects at least one of the soot/dust concentration of the exhaust gas, the ozone concentration of the exhaust gas, the concentration of volatile organic compounds (VOC) in the exhaust gas discharged from the absorption tower, and the concentration of the suspended particulate matter in the exhaust gas; and a control device which controls a charge output in the wet-type electric dust collector. The control device includes a charge output adjustment unit which adjusts a charge output in the wet-type electric dust collector on the basis of at least one of the soot/dust concentration of the exhaust gas, the ozone concentration of the exhaust gas, the concentration of volatile organic compounds in the exhaust gas discharged from the absorption tower, and the concentration of the suspended particulate matter in the exhaust gas detected by the detection unit.

A dust collection device according to the present disclosure is provided in an exhaust gas treatment system including a cooling tower in which a cooling liquid is brought into contact with exhaust gas including carbon dioxide such that the exhaust gas is cooled; an absorption tower into which an absorption liquid capable of absorbing carbon dioxide in the exhaust gas is introduced and in which the absorption liquid absorbs carbon dioxide in the exhaust gas that has gone through the cooling tower; and a regeneration tower in which the absorption liquid that has absorbed carbon dioxide is heated, carbon dioxide is separated from the absorption liquid, and the absorption liquid is regenerated. The dust collection device includes a wet-type electric dust collector in which suspended particulate matter including sulfur trioxide included in the exhaust gas is charged such that the suspended particulate matter is captured; a detection unit which detects at least one of the soot/dust concentration of the exhaust gas, the ozone concentration of the exhaust gas, the concentration of volatile organic compounds in the exhaust gas discharged from the absorption tower, and the concentration of the suspended particulate matter in the exhaust gas; and a control device which controls a charge output in the wet-type electric dust collector. The control device includes a charge output adjustment unit which adjusts a charge output in the wet-type electric dust collector on the basis of at least one of the soot/dust concentration of the exhaust gas, the ozone concentration of the exhaust gas, the concentration of volatile organic compounds in the exhaust gas discharged from the absorption tower, and the concentration of the suspended particulate matter in the exhaust gas detected by the detection unit.

A control method of an exhaust gas treatment system according to the present disclosure is a control method of the exhaust gas treatment system described above including a step of acquiring information including at least one of the soot/dust concentration of the exhaust gas including carbon dioxide, the ozone concentration of the exhaust gas, the concentration of volatile organic compounds in the exhaust gas discharged from the absorption tower, and the concentration of the suspended particulate matter in the exhaust gas; and a step of adjusting a charge output in the wet-type electric dust collector on the basis of at least one of the soot/dust concentration of the exhaust gas, the ozone concentration of the exhaust gas, the concentration of volatile organic compounds in the exhaust gas discharged from the absorption tower, and the concentration of the suspended particulate matter in the exhaust gas.

### Advantageous Effects of Invention

According to the exhaust gas treatment system, the dust collection device, and the control method of an exhaust gas treatment system of the present disclosure, an adverse effect on the performance of exhaust gas treatment can be curbed.

### BRIEF DESCRIPTION OF DRAWINGS

FIG. 1 is a view showing the constitution of an exhaust gas treatment system according to a first embodiment of the present disclosure.

FIG. 2 is a view showing a hardware constitution of a control device of the exhaust gas treatment system according to the embodiment of the present disclosure.

FIG. 3 is a functional block diagram of the control device of the exhaust gas treatment system according to the first embodiment of the present disclosure.

FIG. 4 is a view showing an example of correlation information stored in the control device according to the embodiment of the present disclosure.

FIG. 5 is a flowchart showing a flow of a control method of the exhaust gas treatment system according to the embodiment of the present disclosure.

FIG. 6 is a view showing the constitution of an exhaust gas treatment system according to a second embodiment of the present disclosure.

FIG. 7 is a functional block diagram of control devices of the exhaust gas treatment systems according to the second embodiment and a third embodiment of the present disclosure.

FIG. 8 is a view showing the constitution of an exhaust gas treatment system according to the third embodiment of the present disclosure.

### DESCRIPTION OF EMBODIMENTS

Hereinafter, with reference to the accompanying drawings, embodiments of an exhaust gas treatment system, a dust collection device, and a control method of an exhaust gas treatment system according to the present disclosure will be described. However, the present disclosure is not limited to only these embodiments.

### First Embodiment

### (Constitution of Exhaust Gas Treatment System)

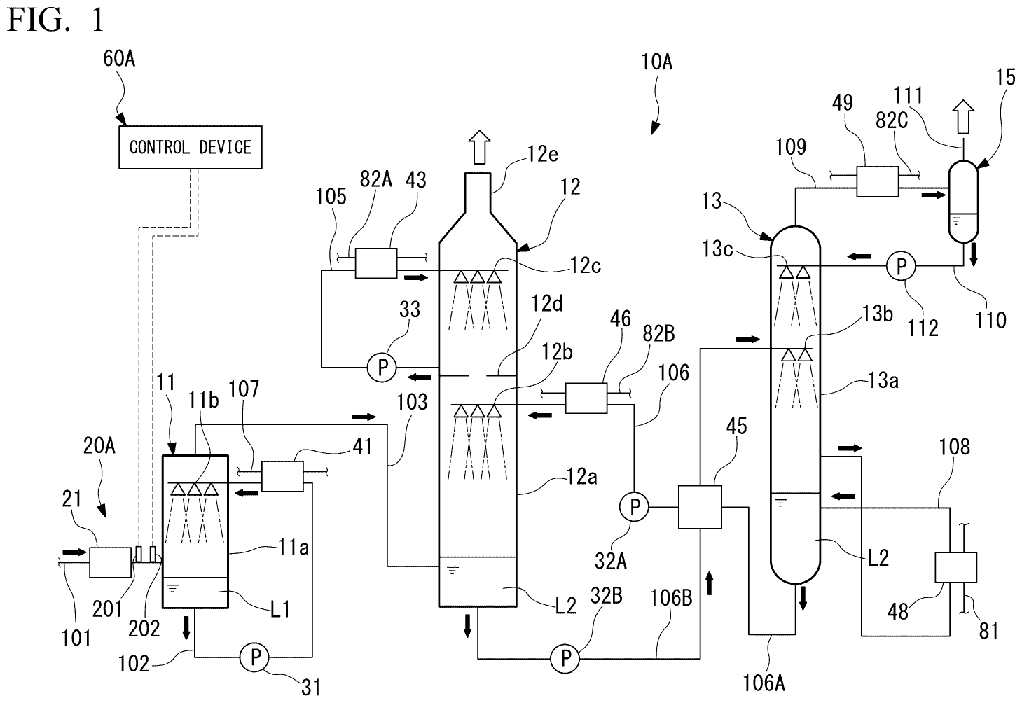

For example, an exhaust gas treatment system 10A shown in FIG. 1 is connected to a gas discharge source (not shown) which is provided in a ship or a plant such as a power plant and discharges exhaust gas including carbon dioxide. Specifically, in the case of a ship, for example, the gas discharge source is an internal-combustion engine used as a main engine for propelling a ship, an internal combustion engine used in a power generation facility supplying power to the inside of a ship, a boiler generating steam, or the like. In addition, in the case of a power plant, the gas discharge source is a blast furnace. In such gas discharge sources, exhaust gas generated by combusting fuel includes carbon dioxide and a sulfur component such as sulfur dioxide (SO₂).

The exhaust gas treatment system 10A collects carbon dioxide included in exhaust gas from the gas discharge source. The exhaust gas treatment system 10A includes a cooling tower 11, an absorption tower 12, a regeneration tower 13, a collection unit 15, and a dust collection device 20A.

In the cooling tower 11, exhaust gas from the gas discharge source is cooled by a cooling liquid L1. When the gas discharge source is provided in a ship, water around the area where the ship is floating or fresh water stored in a fresh water tank (not shown) provided inside the ship can be utilized as the cooling liquid L1. When the gas discharge source is provided in a plant such as a power plant, for example, seawater, river water, industrial water, or the like can be utilized as the cooling liquid L1.

One end of a gas introduction line 101 is connected to a lower portion of the cooling tower 11. The gas introduction line 101 is provided at an entrance of the exhaust gas treatment system 10A, and exhaust gas from the gas discharge source (not shown) outside the exhaust gas treatment system 10A is fed therethrough. The other end of the gas introduction line 101 is connected to a desulfurization device (not shown) provided between the gas discharge source and the cooling tower 11. The desulfurization device removes a sulfur component such as SO₂ included in exhaust gas.

The cooling tower 11 includes a tower main body 11a, and nozzles 11b which spray the cooling liquid L1 from an upper portion inside the tower main body 11a. A cooling liquid supply line 102 for circulating the cooling liquid L1 is connected to the cooling tower 11. One end of the cooling liquid supply line 102 is connected to a bottom portion of the tower main body 11a. The other end of the cooling liquid supply line 102 is connected to the nozzles 11b in the upper portion of the tower main body 11a.

A cooling liquid supply pump 31 and a first heat exchanger 41 are provided in the middle of the cooling liquid supply line 102. The cooling liquid supply pump 31 suctions out the cooling liquid L1 accumulated in the bottom portion of the tower main body 11a from the inside of the tower main body 11a and supplies it to the nozzles 11b in the upper portion of the tower main body 11a. The cooling liquid L1 supplied to the nozzles 11b is sprayed into the tower main body 11a from the nozzles 11b and comes into contact (gas-liquid contact) with exhaust gas that has been fed into the tower main body 11a. Accordingly, the exhaust gas is cooled, and soot, dust, and the like included in the exhaust gas are captured and washed away by the cooling liquid L1.

The first heat exchanger 41 cools the cooling liquid L1 by performing heat exchange between the cooling liquid L1 flowing inside the cooling liquid supply line 102 and cooling water flowing inside a refrigerant line 107.

One end of an exhaust gas outlet line 103 is connected to a top portion of the tower main body 11a. The exhaust gas outlet line 103 feeds exhaust gas, which has been cooled by washing away soot, dust, and the like with the cooling liquid inside the tower main body 11a, to the absorption tower 12.

In the absorption tower 12, carbon dioxide included in exhaust gas is absorbed in an absorption liquid L2. The absorption tower 12 includes a tower main body 12a and nozzles 12b and 12c. The nozzles 12b remove carbon dioxide from exhaust gas by spraying the absorption liquid L2 into the tower main body 12a and bringing it into gas-liquid contact with the exhaust gas. The nozzles 12c spray washing water into the tower main body 12a, and the absorption liquid L2 which has been sprayed from the nozzles 12b and is included in the exhaust gas is collected by bringing it into contact with the exhaust gas which rises inside the tower main body 12a and from which carbon dioxide has been removed. The other end of the exhaust gas outlet line 103 is connected to a lower portion of the tower main body 12a. The exhaust gas that has gone through the cooling tower 11 is fed into the tower main body 12a through the exhaust gas outlet line 103.

The nozzles 12b are provided in the lower portion inside the absorption tower 12. The nozzles 12c are provided in the upper portion inside the absorption tower 12. The absorption liquid L2 is supplied to the nozzles 12b from the regeneration tower 13 through a circulation line 106, which will be described below.

A washing water circulation line 105 for circulating washing water is connected to the absorption tower 12. One end of the washing water circulation line 105 is connected to an intermediate portion of the tower main body 12a. The other end of the washing water circulation line 105 is connected to the nozzles 12c inside the tower main body 12a in the upper portion of the tower main body 12a. A washing water circulation pump 33 and a second heat exchanger 43 are provided in the middle of the washing water circulation line 105. The washing water circulation pump 33 suctions out washing water from above a washing water reservoir 12d provided in an intermediate portion inside the tower main body 12a and supplies to the nozzles 12c in the upper portion of the tower main body 12a.

The absorption liquid L2 which has been supplied to the nozzles 12b is sprayed into the tower main body 12a and comes into contact with exhaust gas which has been fed into the tower main body 12a. Accordingly, carbon dioxide included in exhaust gas is absorbed by the absorption liquid L2 inside the tower main body 12a of the absorption tower 12.

A cooling water supply pipe 82A is connected to the second heat exchanger 43. Through this cooling water supply pipe 82A, cooling water is supplied to the second heat exchanger 43 from the outside of the exhaust gas treatment system 10A. The second heat exchanger 43 performs heat exchange between cooling water supplied from the outside of the exhaust gas treatment system 10A and washing water flowing inside the washing water circulation line 105. In other words, the second heat exchanger 43 cools washing water circulating through the washing water circulation line 105 with cooling water supplied from the outside of the exhaust gas treatment system 10A. Washing water cooled by the second heat exchanger 43 is sprayed into the tower main body 12a from the nozzles 12c in the upper portion of the tower main body 12a.

One end of an exhaust pipe 12e is connected to a top portion of the tower main body 12a. The exhaust pipe 12e guides exhaust gas which has come out from the absorption tower 12, in other words, exhaust gas from which the absorption liquid L2 has been removed by the absorption tower 12, for example, to an exhaust funnel (not shown) or the like and releases it into the atmosphere.

In the regeneration tower 13, gaseous carbon dioxide is separated from the absorption liquid L2 which has absorbed carbon dioxide in the absorption tower 12.

The regeneration tower 13 includes a tower main body 13a, nozzles 13b which spray the absorption liquid L2 into the tower main body 13a, and nozzles 13c which spray condensed water which has been refluxed. The nozzles 13b are provided in the lower portion inside the tower main body 13a. The nozzles 13c are provided in the upper portion inside the tower main body 13a.

The circulation line 106 is provided between the absorption tower 12 and the regeneration tower 13. The circulation line 106 causes the absorption liquid L2 to circulate between the absorption tower 12 and the regeneration tower 13. The circulation line 106 includes an absorption liquid supply line 106A, an absorption liquid discharge line 106B, and a heat exchanger 45.

One end of the absorption liquid supply line 106A is connected to a bottom portion of the tower main body 13a of the regeneration tower 13. The other end of the absorption liquid supply line 106A is connected to the nozzles 12b inside in the tower main body 12a of the absorption tower 12. A first circulation pump 32A and a third heat exchanger 46 are provided in the middle of the absorption liquid supply line 106A. The first circulation pump 32A suctions out the absorption liquid L2 from the bottom portion of the tower main body 13a of the regeneration tower 13 through the absorption liquid supply line 106A and supplies it to the nozzles 12b in the tower main body 12a of the absorption tower 12.

A cooling water supply pipe 82B is connected to the third heat exchanger 46. Cooling water is supplied to the third heat exchanger 46 from the outside of the exhaust gas treatment system 10A through the cooling water supply pipe 82B. The third heat exchanger 46 performs heat exchange between cooling water supplied from the outside of the exhaust gas treatment system 10A and the absorption liquid L2 flowing inside the absorption liquid supply line 106A. In other words, the third heat exchanger 46 cools the absorption liquid L2 supplied to the absorption tower 12 through the absorption liquid supply line 106A with cooling water supplied from the outside of the exhaust gas treatment system 10A. The absorption liquid L2 which has been cooled by the third heat exchanger 46 is sprayed into the tower main body 12a from the nozzles 12b in the absorption tower 12.

One end of the absorption liquid discharge line 106B is connected to a bottom portion of the tower main body 12a of the absorption tower 12. The other end of the absorption liquid discharge line 106B is connected to the nozzles 13b provided inside the tower main body 13a of the regeneration tower 13. A second circulation pump 32B is provided in the middle of the absorption liquid discharge line 106B. The second circulation pump 32B suctions out the absorption liquid L2 from the bottom portion of the tower main body 12a of the absorption tower 12 through the absorption liquid discharge line 106B and supplies it to the nozzles 13b in the tower main body 13a of the regeneration tower 13.

The heat exchanger 45 performs heat exchange between the absorption liquid L2 flowing inside the absorption liquid supply line 106A and the absorption liquid L2 flowing inside the absorption liquid discharge line 106B. In other words, due to the heat of the absorption liquid L2 immediately after carbon dioxide has been separated by the regeneration tower 13, the absorption liquid L2 which has absorbed carbon dioxide before it is introduced into the regeneration tower 13 is heated.

In the regeneration tower 13, gaseous carbon dioxide is separated from the absorption liquid L2 which has absorbed carbon dioxide in the absorption tower 12. For this reason, in the regeneration tower 13, the absorption liquid L2 which has been sent into the regeneration tower 13 from the absorption tower 12 through the absorption liquid discharge line 106B is heated by an absorption liquid heating line 108.

The absorption liquid heating line 108 is connected to the regeneration tower 13. The absorption liquid heating line 108 causes the absorption liquid L2 to circulate between the regeneration tower 13 and a reboiler 48. Namely, the absorption liquid heating line 108 supplies the absorption liquid L2 which has been drawn out from the regeneration tower 13 to the reboiler 48 and returns the absorption liquid L2 into the regeneration tower 13 from the reboiler 48. To put it another way, the reboiler 48 is provided in the middle of the absorption liquid heating line 108.

A steam supply pipe 81 is connected to the reboiler 48. Steam supplied from a boiler (not shown) or the like provided outside the exhaust gas treatment system 10A is fed into the reboiler 48 through the steam supply pipe 81. The reboiler 48 performs heat exchange between steam which has been fed through the steam supply pipe 81 and the absorption liquid L2 flowing inside the absorption liquid heating line 108. Namely, the reboiler 48 heats the absorption liquid L2 with heat of steam.

The reboiler 48 separates gaseous carbon dioxide from the absorption liquid L2 by heating the absorption liquid L2. The absorption liquid L2 and gaseous carbon dioxide separated in the reboiler 48 return to the inside of the tower main body 13a through the absorption liquid heating line 108. In this manner, the absorption liquid L2 which has been regenerated after gaseous carbon dioxide is separated returns to the absorption tower 12 through the absorption liquid supply line 106A and is reused. On the other hand, separated gaseous carbon dioxide is fed into the collection unit 15 through a gaseous carbon dioxide discharge line 109.

A condenser 49 is provided in the middle of the gaseous carbon dioxide discharge line 109. A cooling water supply pipe 82C is connected to the condenser 49. Cooling water is supplied to the condenser 49 from the outside of the exhaust gas treatment system 10A through the cooling water supply pipe 82C. The condenser 49 condenses moisture included in gaseous carbon dioxide by heat exchange with cooling water supplied from the outside of the exhaust gas treatment system 10A.

The collection unit 15 collects gaseous carbon dioxide which has been separated in the regeneration tower 13. The collection unit 15 is a gas-liquid separator, which performs gas-liquid separation between gaseous carbon dioxide which has been fed through the condenser 49 and condensed water in which moisture is condensed.

Condensed water after gas-liquid separation is refluxed to the regeneration tower 13 from a bottom portion of the collection unit 15 through a reflux line 110. A reflux pump 112 for refluxing condensed water to the regeneration tower 13 is provided in the middle of the reflux line 110. The reflux line 110 is connected to the nozzles 13c provided in an upper portion of the regeneration tower 13. Condensed water which has been refluxed to the regeneration tower 13 is sprayed into the tower main body 13a from the nozzles 13c in the regeneration tower 13 as the absorption liquid L2.

On the other hand, gaseous carbon dioxide from which moisture has been removed in the collection unit 15 is discharged to the outside of the exhaust gas treatment system 10A through a carbon dioxide discharge pipe 111. Gaseous carbon dioxide which has been discharged through the carbon dioxide discharge pipe 111 is stored in a carbon dioxide collection tank (not shown), for example. At this time, gaseous carbon dioxide may be liquefied by a suitable carbon dioxide liquefaction device and stored in the carbon dioxide collection tank.

In the exhaust gas treatment system 10A described above, exhaust gas discharged from the gas discharge source (not shown) is washed in the cooling tower 11 and then introduced into the absorption tower 12. In the absorption tower 12, carbon dioxide included in exhaust gas is absorbed by the absorption liquid L2. Exhaust gas from which carbon dioxide has been separated by the absorption liquid L2 which has absorbed the carbon dioxide is released into the atmosphere. In addition, the absorption liquid L2 which has absorbed carbon dioxide included in exhaust gas in the absorption tower 12 is sent to the regeneration tower 13 through the circulation line 106. The absorption liquid L2 which has absorbed carbon dioxide is heated by the reboiler 48 so that its temperature rises and therefore gaseous carbon dioxide included in the absorption liquid L2 is separated. Separated gaseous carbon dioxide is collected through the collection unit 15. On the other hand, the absorption liquid L2 from which carbon dioxide is separated inside the regeneration tower 13 circulates to the absorption tower 12 through the circulation line 106.

### (Constitution of Dust Collection Device)

The dust collection device 20A captures suspended particulate matter included in exhaust gas which has been fed into the absorption tower 12. The dust collection device 20A includes a wet-type electric dust collector 21, detection units 201 and 202, and a control device 60A which adjusts a charge output in the wet-type electric dust collector 21.

For example, the wet-type electric dust collector 21 according to this embodiment is provided in the middle of the gas introduction line 101, namely, on the upstream side of the cooling tower 11. The wet-type electric dust collector 21 may be provided in the exhaust gas outlet line 103 on the downstream side of the cooling tower 11. The wet-type electric dust collector 21 captures suspended particulate matter by charging the suspended particulate matter including sulfur trioxide included in exhaust gas. The wet-type electric dust collector 21 has a discharging electrode (not shown). The wet-type electric dust collector 21 captures suspended particulate matter in exhaust gas due to an electrostatic force by charging the suspended particulate matter through electric discharge from the discharging electrode. Here, suspended particulate matter includes droplets (mist) of sulfur trioxide included in exhaust gas, and soot and dust (solid particles). The wet-type electric dust collector 21 collects captured suspended particulate matter by bringing it into contact with water.

The detection units 201 and 202 are provided on the downstream side with respect to the wet-type electric dust collector 21 in the gas introduction line 101. The detection unit 201 repeatedly detects, at regular time intervals, the soot/dust concentration of exhaust gas that has gone through the wet-type electric dust collector 21. The detection unit 202 repeatedly detects, at regular time intervals, the ozone concentration of exhaust gas that has gone through the wet-type electric dust collector 21. The detection units 201 and 202 outputs a detected concentration detection value to the control device 60A.

### (Hardware Constitution Diagram)

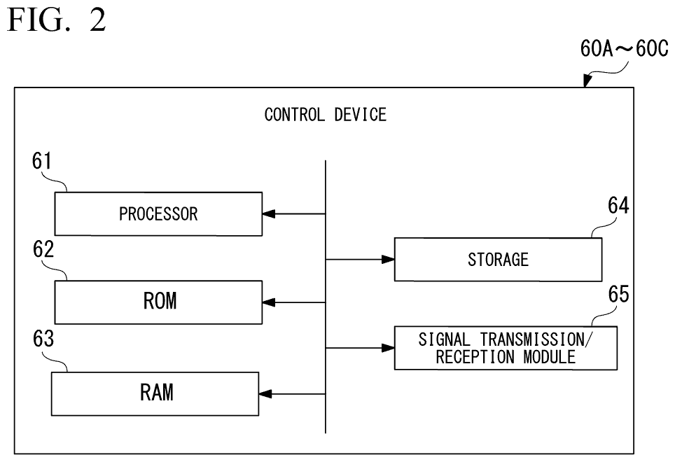

FIG. 2 is a view showing a hardware constitution of a control device of the exhaust gas treatment system according to the embodiment of the present disclosure.

As shown in FIG. 2, the control device 60A is a computer including a processor 61 such as a central processing unit (CPU), a read only memory (ROM) 62, a random-access memory (RAM) 63, a storage 64, and a signal transmission/reception module 65. From each of the detection units 201 and 202, the signal transmission/reception module 65 receives a signal related to the concentration detection value of the soot/dust concentration of exhaust gas that has gone through the wet-type electric dust collector 21 and the ozone concentration of exhaust gas that has gone through the wet-type electric dust collector 21.

### (Functional Block Diagram)

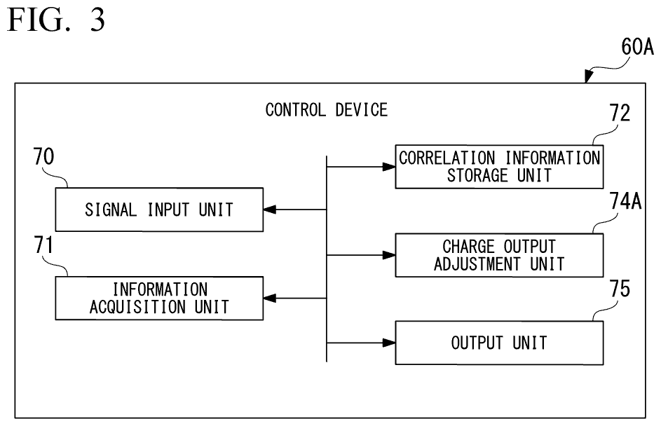

FIG. 3 is a functional block diagram of the control device of the exhaust gas treatment system according to the embodiment of the present disclosure.

As shown in FIG. 3, the processor 61 of the control device 60A realizes each of the constitutions of a signal input unit 70, an information acquisition unit 71, a correlation information storage unit 72, a charge output adjustment unit 74A, and an output unit 75 by executing a program stored in advance in a storage device such as the ROM 62 or the storage 64.

The signal input unit 70 receives a signal related to the concentration detection value from each of the detection units 201 and 202 through the signal transmission/reception module 65 that is hardware.

The information acquisition unit 71 acquires the concentration detection value detected by each of the detection units 201 and 202 on the basis of a signal received by the signal input unit 70.

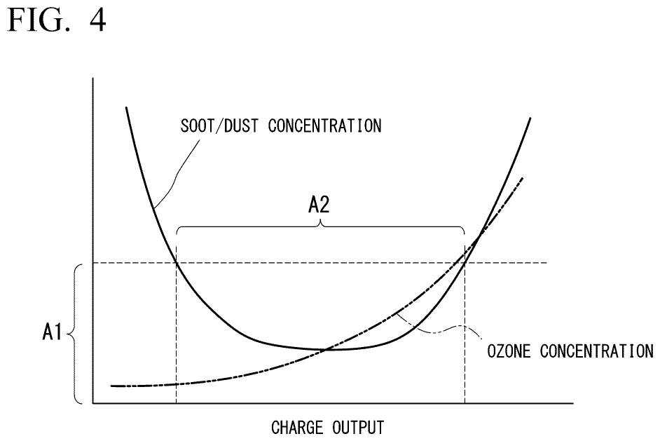

FIG. 4 is a view showing an example of correlation information stored in the control device according to the embodiment of the present disclosure.

For example, as shown in FIG. 4, the correlation information storage unit 72 stores correlation information related to correlation between the soot/dust concentration of exhaust gas and the ozone concentration of exhaust gas, and the charge output in the wet-type electric dust collector 21. This correlation information is acquired by performing a test drive of the wet-type electric dust collector 21, or the like in advance.

The charge output adjustment unit 74A adjusts the charge output in the wet-type electric dust collector 21 on the basis of the soot/dust concentration of exhaust gas and the ozone concentration of exhaust gas detected by the detection units 201 and 202. The charge output adjustment unit 74A adjusts the charge output in the wet-type electric dust collector 21 on the basis of the soot/dust concentration of exhaust gas and the ozone concentration of exhaust gas detected by the detection units 201 and 202, and the correlation information stored in the correlation information storage unit 72. The charge output adjustment unit 74A adjusts the charge output in the wet-type electric dust collector 21 such that the soot/dust concentration of exhaust gas and the ozone concentration of exhaust gas become equal to or lower than a reference value set in advance. For example, when at least one of the soot/dust concentration of exhaust gas and the ozone concentration of exhaust gas detected by the detection units 201 and 202 deviates from the concentration range Al set in advance, the charge output adjustment unit 74A adjusts the charge output in the wet-type electric dust collector 21 to be within a charge output range A2 set in advance.

The output unit 75 outputs a control signal for changing the charge output in the wet-type electric dust collector 21 on the basis of control of the charge output adjustment unit 74A.

### (Procedure of Control Method of Exhaust Gas Treatment System)

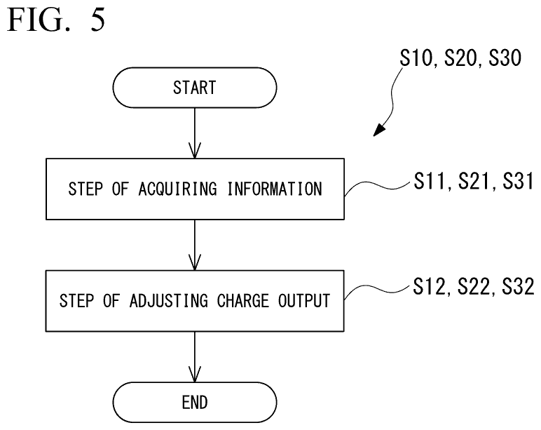

FIG. 5 is a flowchart showing a flow of a control method of the exhaust gas treatment system according to the embodiment of the present disclosure. In this embodiment, a control method S10 of an exhaust gas treatment system which will be described below is realized by the control device 60A sequentially executing processing based on the program stored in advance.

As shown in FIG. 5, the control method S10 of an exhaust gas treatment system according to this embodiment includes Step S11 of acquiring information and Step S12 of adjusting a charge output.

In Step S11 of acquiring information, information including the soot/dust concentration of exhaust gas including carbon dioxide and the ozone concentration of exhaust gas is acquired. To this end, the signal input unit 70 receives the concentration detection value of the soot/dust concentration of exhaust gas that has gone through the wet-type electric dust collector 21 and has been detected by the detection unit 201, and the concentration detection value of the ozone concentration of exhaust gas that has gone through the wet-type electric dust collector 21 and has been detected by the detection unit 202 at regular time intervals. The information acquisition unit 71 acquires the soot/dust concentration of exhaust gas and the ozone concentration of exhaust gas on the basis of a signal received by the signal input unit 70.

In Step S12 of adjusting a charge output, the charge output adjustment unit 74A adjusts the charge output in the wet-type electric dust collector 21 on the basis of the soot/dust concentration of exhaust gas and the ozone concentration of exhaust gas acquired by the information acquisition unit 71.

In this embodiment, for example, the charge output adjustment unit 74A refers to the correlation information stored in the correlation information storage unit 72. When at least one of the soot/dust concentration of exhaust gas and the ozone concentration of exhaust gas detected by the detection units 201 and 202 deviates from the concentration range Al set in advance, the charge output in the wet-type electric dust collector 21 is decreased and it is adjusted to be within the charge output range A2 set in advance,

The control device 60A repeatedly executes Steps S11 and S12 described above at regular time intervals while the exhaust gas treatment system 10A is in operation.

### (Operational Effects)

In the exhaust gas treatment system 10A, the dust collection device 20A, and the control method S10 of the exhaust gas treatment system 10A having the foregoing constitutions, the charge output in the wet-type electric dust collector 21 is adjusted on the basis of the soot/dust concentration of exhaust gas including carbon dioxide and the ozone concentration of exhaust gas. Accordingly, excessive charging in the wet-type electric dust collector 21 can be curbed so that increase in suspended particulate matter of sulfur trioxide and increase in ozone as a byproduct can be curbed. Since suspended particulate matter of sulfur trioxide is extremely fine, it captures amine vapor inside the absorption tower 12 and is unlikely to be captured by a filling or a demister inside the absorption tower 12. Consumption of amines included in the absorption liquid L2 can be curbed, an adverse effect on the environment can be reduced, and oxidative deterioration in the absorption liquid L2 caused by ozone can be curbed by curbing such increase in suspended particulate matter of sulfur trioxide. As a result, an adverse effect on the performance of exhaust gas treatment can be curbed.

In addition, the control device 60A adjusts the charge output in the wet-type electric dust collector 21 on the basis of the soot/dust concentration of exhaust gas and the ozone concentration of exhaust gas detected by the detection units 201 and 202, and the correlation information stored in the correlation information storage unit 72. Accordingly, the charge output can be easily controlled.

In addition, when at least one of the soot/dust concentration of exhaust gas and the ozone concentration of exhaust gas deviates from the concentration range set in advance, the control device 60A adjusts the charge output to be within the charge output range set in advance. Accordingly, excessive charging in the wet-type electric dust collector 21 can be curbed at an appropriate timing. In addition, when at least one of the soot/dust concentration of exhaust gas and the ozone concentration of exhaust gas deviates from the concentration range Al set in advance, power consumption in the wet-type electric dust collector 21 can be curbed by decreasing the charge output in the wet-type electric dust collector 21.

### Second Embodiment

Next, a second embodiment of the exhaust gas treatment system and the control method of an exhaust gas treatment system according to the present disclosure will be described. In the second embodiment described below, the same reference signs are applied to constitutions common to the foregoing first embodiment in the diagrams, and description thereof will be omitted. In the second embodiment, the constitution of a control device 60B differs from that of the first embodiment.

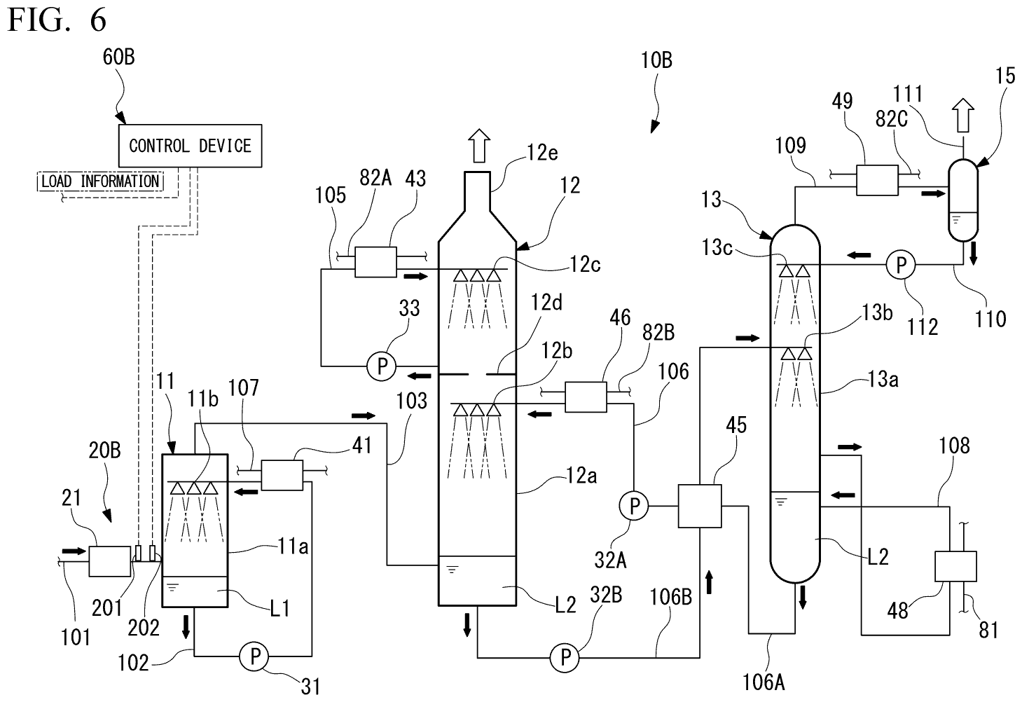

FIG. 6 is a view showing the constitution of an exhaust gas treatment system according to the second embodiment of the present disclosure,

As shown in FIG. 6, an exhaust gas treatment system 10B includes the cooling tower 11, the absorption tower 12, the regeneration tower 13, the collection unit 15, and a dust collection device 20B.

The dust collection device 20B according to this embodiment includes the wet-type electric dust collector 21, the detection units 201 and 202, and the control device 60B adjusting the charge output in the wet-type electric dust collector 21.

### (Functional Block Diagram)

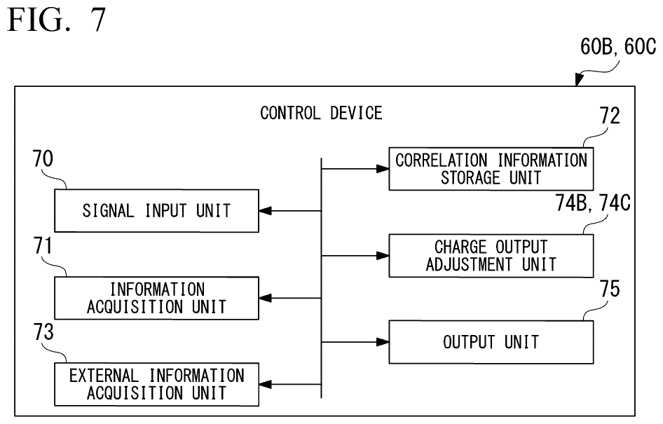

FIG. 7 is a functional block diagram of the control device of the exhaust gas treatment system according to the second embodiment of the present disclosure.

As shown in FIG. 7, the processor 61 of the control device 60B according to this embodiment realizes each of the constitutions of the signal input unit 70, the information acquisition unit 71, the correlation information storage unit 72, an external information acquisition unit 73, a charge output adjustment unit 74B, and the output unit 75 by executing a program stored in advance in a storage device such as the ROM 62 or the storage 64.

The external information acquisition unit 73 acquires information related to the discharge amount of exhaust gas from an external gas discharge source discharging exhaust gas. For example, the external information acquisition unit 73 acquires information indicating the load on the gas discharge source from a control unit (not shown) of the gas discharge source as the information related to the discharge amount of exhaust gas. The discharge amount of exhaust gas from the gas discharge source changes in accordance with the load on the gas discharge source. Specifically, the greater the load on the gas discharge source, the larger the discharge amount of exhaust gas. The smaller the load on the gas discharge source, the smaller the discharge amount of exhaust gas. The external information acquisition unit 73 may acquire the discharge amount of exhaust gas from the gas discharge source, for example, as the information related to the discharge amount of exhaust gas,

The charge output adjustment unit 74B adjusts the charge output in the wet-type electric dust collector 21 on the basis of the soot/dust concentration of exhaust gas and the ozone concentration of exhaust gas detected by the detection units 201 and 202. In addition, the charge output adjustment unit 74B adjusts the charge output in the wet-type electric dust collector 21 on the basis of the information related to the discharge amount of exhaust gas acquired by the external information acquisition unit 73. When the load on the gas discharge source is smaller than the reference value set in advance, the charge output adjustment unit 74B decreases the charge output in the wet-type electric dust collector 21 on the basis of the magnitude of the acquired load on the gas discharge source. Accordingly, when the discharge amount of exhaust gas is substantially smaller than a discharge amount reference value set in advance, the charge output adjustment unit 74B decreases the charge output in the wet-type electric dust collector 21 on the basis of the information related to the discharge amount of exhaust gas.

### (Procedure of Control Method of Exhaust Gas Treatment System)

As shown in FIG. 5, a control method S20 of an exhaust gas treatment system according to this embodiment includes Step S21 of acquiring information and Step S22 of adjusting a charge output.

In Step S21 of acquiring information, in addition to information including the soot/dust concentration of exhaust gas including carbon dioxide and the ozone concentration of exhaust gas, information related to the discharge amount of exhaust gas is acquired. To this end, the concentration detection value of the soot/dust concentration of exhaust gas and the concentration detection value of the ozone concentration of exhaust gas detected by the detection units 201 and 202 are acquired by the information acquisition unit 71. Furthermore, information related to the discharge amount of exhaust gas from the external gas discharge source discharging exhaust gas is acquired by the external information acquisition unit 73.

In Step S22 of adjusting a charge output, the charge output in the wet-type electric dust collector 21 is adjusted by the charge output adjustment unit 74B on the basis of the soot/dust concentration of exhaust gas and the ozone concentration of exhaust gas acquired by the information acquisition unit 71. In addition, the charge output adjustment unit 74B adjusts the charge output in the wet-type electric dust collector 21 on the basis of the information related to the discharge amount of exhaust gas acquired by the external information acquisition unit 73.

In this embodiment, for example, when the load on the gas discharge source acquired by the external information acquisition unit 73 is smaller than a load reference value set in advance, the charge output adjustment unit 74B decreases the charge output in the wet-type electric dust collector 21.

The control device 60B repeatedly executes Steps S21 and S22 described above at regular time intervals while the exhaust gas treatment system 10B is in operation.

### (Operational Effects)

In the exhaust gas treatment system 10B, the dust collection device 20B, and the control method S20 of the exhaust gas treatment system 10B having the foregoing constitutions, similar to the foregoing first embodiment, excessive charging in the wet-type electric dust collector 21 is curbed. Accordingly, increase in suspended particulate matter of sulfur trioxide and increase in ozone as a byproduct can be curbed, and therefore an adverse effect on the performance of exhaust gas treatment can be curbed.

In addition, the control device 60B adjusts the charge output in the wet-type electric dust collector 21 in accordance with the discharge amount of exhaust gas from the external gas discharge source. Accordingly, excessive charging in the wet-type electric dust collector 21 with respect to the discharge amount of exhaust gas can be curbed.

In addition, when the load on the gas discharge source is small, the control device 60B decreases the charge output in the wet-type electric dust collector 21. Accordingly, excessive charging in the wet-type electric dust collector 21 can be curbed at an appropriate timing.

### Third Embodiment

Next, a third embodiment of the exhaust gas treatment system and the control method of an exhaust gas treatment system according to the present disclosure will be described. In the third embodiment described below, the same reference signs are applied to constitutions common to the foregoing first and second embodiments in the diagrams, and description thereof will be omitted. In the third embodiment, the constitution of a control device 60C differs from those of the first and second embodiments.

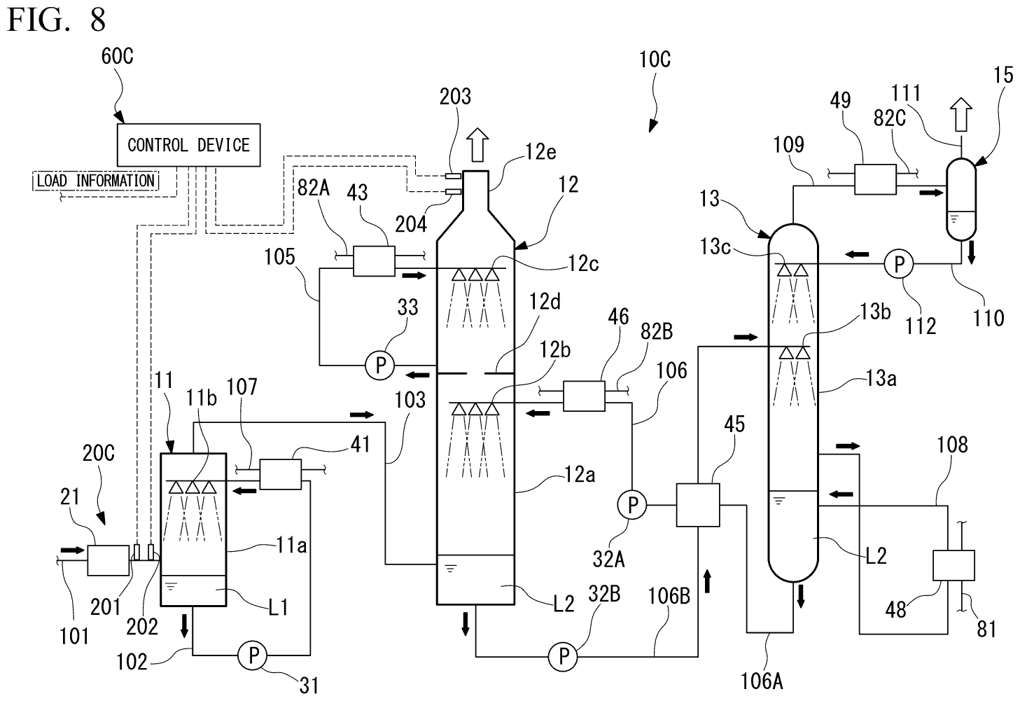

FIG. 8 is a view showing the constitution of an exhaust gas treatment system according to the third embodiment of the present disclosure.

As shown in FIG. 8, an exhaust gas treatment system 10C includes the cooling tower 11, the absorption tower 12, the regeneration tower 13, the collection unit 15, and a dust collection device 20C.

The dust collection device 20C according to this embodiment includes the wet-type electric dust collector 21, the detection units 201 and 202, discharge concentration detection units (detection units) 203 and 204, and the control device 60C adjusting the charge output in the wet-type electric dust collector 21.

The discharge concentration detection units 203 and 204 are provided in the exhaust pipe 12e of the absorption tower 12. The discharge concentration detection unit 203 detects the concentration of volatile organic compounds (VOC) in exhaust gas discharged from the absorption tower 12. The discharge concentration detection unit 204 detects the concentration of suspended particulate matter in exhaust gas discharged from the absorption tower 12.

### (Functional Block Diagram)

As shown in FIG. 7, the processor 61 of the control device 60C according to this embodiment realizes each of the constitutions of the signal input unit 70, the information acquisition unit 71, the correlation information storage unit 72, the external information acquisition unit 73, a charge output adjustment unit 74C, and the output unit 75 by executing a program stored in advance in a storage device such as the ROM 62 or the storage 64.

When the charge output in the wet-type electric dust collector 21 is adjusted on the basis of the soot/dust concentration of exhaust gas and the ozone concentration of exhaust gas detected by the detection units 201 and 202, the charge output adjustment unit 74C adjusts the charge output in the wet-type electric dust collector 21 on the basis of the information related to the discharge amount of exhaust gas acquired by the external information acquisition unit 73.

Moreover, the charge output adjustment unit 74C according to this embodiment adjusts the charge output in the wet-type electric dust collector 21 on the basis of the concentration of volatile organic compounds and the concentration of suspended particulate matter in exhaust gas discharged from the absorption tower 12 and detected by the discharge concentration detection units 203 and 204. When at least one of the concentration of volatile organic compounds and the concentration of suspended particulate matter in exhaust gas discharged from the absorption tower 12 is higher than the reference value set in advance, the charge output adjustment unit 74C decreases the charge output in the wet-type electric dust collector 21.

### (Procedure of Control Method of Exhaust Gas Treatment System)

As shown in FIG. 5, a control method S30 of an exhaust gas treatment system according to this embodiment includes Step S31 of acquiring information and Step S32 of adjusting a charge output.

In Step S31 of acquiring information, in addition to information including the soot/dust concentration of exhaust gas including carbon dioxide and the ozone concentration of exhaust gas, and information related to the discharge amount of exhaust gas, the concentration of volatile organic compounds and the concentration of suspended particulate matter in exhaust gas discharged from the absorption tower 12 are acquired. To this end, information including the concentration of volatile organic compounds and the concentration of suspended particulate matter detected by the discharge concentration detection units 203 and 204 are acquired by the information acquisition unit 71.

In Step S32 of adjusting a charge output, the charge output in the wet-type electric dust collector 21 is adjusted by the charge output adjustment unit 74C on the basis of the soot/dust concentration of exhaust gas and the ozone concentration of exhaust gas acquired by the information acquisition unit 71. In addition, the charge output adjustment unit 74C adjusts the charge output in the wet-type electric dust collector 21 on the basis of the information related to the discharge amount of exhaust gas acquired by the external information acquisition unit 73.

Moreover, in this embodiment, when at least one of the concentration of volatile organic compounds and the concentration of suspended particulate matter is higher than the reference value set in advance, the charge output adjustment unit 74C decreases the charge output in the wet-type electric dust collector 21.

The control device 60C repeatedly executes Steps S31 and S32 described above at regular time intervals while the exhaust gas treatment system 10C is in operation.

### (Operational Effects)

In the exhaust gas treatment system 10C, the dust collection device 20C, and the control method S30 of the exhaust gas treatment system 10C having the foregoing constitutions, similar to the foregoing first and second embodiments, excessive charging in the wet-type electric dust collector 21 is curbed. Accordingly, increase in suspended particulate matter of sulfur trioxide and increase in ozone as a byproduct can be curbed, and therefore an adverse effect on the performance of exhaust gas treatment can be curbed.

In addition, the control device 60C adjusts the charge output in the wet-type electric dust collector 21 on the basis of at least one of the concentration of volatile organic compounds and the concentration of suspended particulate matter in exhaust gas discharged from the absorption tower 12, and therefore excessive charging in the wet-type electric dust collector 21 can be curbed.

In the present embodiment, the detection units 201 and 202 and the external information acquisition unit 73 are provided, but the embodiment is not limited thereto. The dust collection device 20C of the present embodiment may include only the discharge concentration detection units 203 and 204 without including the detection units 201 and 202 and the external information acquisition unit 73.

### (Other Embodiments)

Hereinabove, embodiments of the present disclosure have been described in detail with reference to the drawings, but the specific constitutions thereof are not limited to these embodiments, and design change and the like within a range not departing from the gist of the present disclosure are also included.

In each of the foregoing embodiments, the detection unit 201 detecting the soot/dust concentration of exhaust gas from the gas discharge source and the detection unit 202 detecting the ozone concentration of exhaust gas from the gas discharge source are provided, but the embodiments are not limited thereto. At least one of the detection unit 201 detecting the soot/dust concentration of exhaust gas from the gas discharge source and the detection unit 202 detecting the ozone concentration of exhaust gas from the gas discharge source need only be provided.

In addition, in each of the foregoing embodiments, the discharge concentration detection unit 203 detecting the concentration of volatile organic compounds in exhaust gas discharged from the absorption tower 12, and the discharge concentration detection unit 204 detecting the concentration of suspended particulate matter in exhaust gas discharged from the absorption tower 12 are provided, but the embodiments are not limited thereto. At least one of the discharge concentration detection unit 203 and the discharge concentration detection unit 204 need only be provided.

Each of the functional units may perform processing by recording a program for realizing all or some of the functions of the control devices 60A to 60C in a computer-readable recording medium, causing a computer system to read and execute the program recorded in this recording medium. It is assumed that the said “computer system” includes an OS and hardware such as peripheral instruments. In addition, it is assumed that the “computer system” also includes a homepage provision environment (or a homepage display environment) if the WWW system is utilized. In addition, a “computer-readable recording medium” denotes a portable medium such as a CD, a DVD, or a USB, or a storage device such as a hard disk built into the computer system. In addition, when this program is distributed to the control devices 60A to 60C through a communication line, the control devices 60A to 60C which have received distribution may develop the program in the storage 64 and execute the foregoing processing. In addition, the foregoing program may realize some of the functions described above or may further be able to realize the functions described above in a combination with a program which has already been recorded in the computer system.

### Appendix

The exhaust gas treatment systems 10A to 10C, the dust collection device 20A, and the control methods S10, S20, and S30 of the exhaust gas treatment systems 10A to 10C described in each of the embodiments are ascertained as follows, for example.
(1) Exhaust gas treatment systems 10A to 10C according to a first aspect include) a cooling tower 11 in which a cooling liquid is brought into contact with exhaust gas including carbon dioxide such that the exhaust gas is cooled; an absorption tower 12 into which an absorption liquid capable of absorbing carbon dioxide in the exhaust gas is introduced and in which the absorption liquid absorbs carbon dioxide in the exhaust gas that has gone through the cooling tower 11; a regeneration tower 13 in which the absorption liquid that has absorbed carbon dioxide is heated, carbon dioxide is separated from the absorption liquid, and the absorption liquid is regenerated; a wet-type electric dust collector 21 in which suspended particulate matter including sulfur trioxide (SO3) included in the exhaust gas is charged such that the suspended particulate matter is captured; detection units 201 to 204 which detect at least one of the soot/dust concentration of the exhaust gas, the ozone concentration of the exhaust gas, the concentration of volatile organic compounds in the exhaust gas discharged from the absorption tower 12, and the concentration of the suspended particulate matter in the exhaust gas; and a control device 60A which controls a charge output in the wet-type electric dust collector 21. The control device 60A includes charge output adjustment units 74A to 74C which adjust a charge output in the wet-type electric dust collector 21 on the basis of at least one of the soot/dust concentration of the exhaust gas, the ozone concentration of the exhaust gas, the concentration of volatile organic compounds in the exhaust gas discharged from the absorption tower 12, and the concentration of the suspended particulate matter in the exhaust gas detected by the detection units 201 to 204.

In these exhaust gas treatment systems 10A to 10C, excessive charging in the wet-type electric dust collector 21 is curbed by adjusting the charge output in the wet-type electric dust collector 21 on the basis of at least one of the soot/dust concentration of the exhaust gas including carbon dioxide, the ozone concentration of the exhaust gas, the concentration of volatile organic compounds in the exhaust gas discharged from the absorption tower 12, and the concentration of the suspended particulate matter in the exhaust gas. Accordingly, an increase in suspended particulate matter of sulfur trioxide and an increase in ozone as a byproduct can be curbed, and therefore an adverse effect on the performance of exhaust gas treatment can be curbed.
(2) The exhaust gas treatment systems 10A to 10C according to a second aspect are the exhaust gas treatment systems 10A to 10C according to (1) further having a correlation information storage unit 72 which stores correlation information related to a correlation between at least one of the soot/dust concentration of the exhaust gas and the ozone concentration of the exhaust gas and the charge output. The detection units 201 and 202 detect at least one of the soot/dust concentration of the exhaust gas and the ozone concentration of the exhaust gas. The control device 60A adjusts a charge output in the wet-type electric dust collector 21 such that at least one of the soot/dust concentration of the exhaust gas and the ozone concentration of the exhaust gas becomes equal to or lower than a reference value set in advance on the basis of at least one of the soot/dust concentration of the exhaust gas and the ozone concentration of the exhaust gas detected by the detection units 201 and 202, and the correlation information stored in the correlation information storage unit 72.

Accordingly, the charge output can be easily controlled by adjusting the charge output in the wet-type electric dust collector 21 on the basis of at least one of the soot/dust concentration of the exhaust gas and the ozone concentration of the exhaust gas detected by the detection units 201 and 202, and the correlation information stored in the correlation information storage unit 72.
(3) The exhaust gas treatment systems 10A to 10C according to a third aspect are the exhaust gas treatment systems 10A to 10C according to (2), in which when at least one of the soot/dust concentration of the exhaust gas and the ozone concentration of the exhaust gas detected by the detection units 201 and 202 deviates from the concentration range set in advance, the control device 60A adjusts a charge output in the wet-type electric dust collector 21 to be within a charge output range set in advance.

Accordingly, when at least one of the soot/dust concentration of the exhaust gas and the ozone concentration of the exhaust gas deviates from the concentration range set in advance, excessive charging in the wet-type electric dust collector 21 can be curbed at an appropriate timing by adjusting the charge output to be within the charge output range set in advance.
(4) The exhaust gas treatment system 10B according to a fourth aspect is the exhaust gas treatment system 10B according to any one of (1) to (3), in which the control device 60B further includes an external information acquisition unit 73 which acquires information related to a discharge amount of the exhaust gas from an external gas discharge source discharging the exhaust gas. The charge output adjustment unit 74B adjusts a charge output in the wet-type electric dust collector 21 on the basis of the information related to the discharge amount of the exhaust gas acquired by the external information acquisition unit 73.

Accordingly, excessive charging in the wet-type electric dust collector 21 can be curbed with respect to the discharge amount of the exhaust gas by adjusting the charge output in the wet-type electric dust collector 21 in accordance with the information related to the discharge amount of the exhaust gas from the external gas discharge source.
(5) The exhaust gas treatment system 10B according to a fifth aspect is the exhaust gas treatment system 10B according to (4), in which when the discharge amount of the exhaust gas is smaller than a discharge amount reference value set in advance, the control device 60B decreases a charge output in the wet-type electric dust collector 21 on the basis of the information related to the discharge amount of the exhaust gas acquired by the external information acquisition unit 73.

Accordingly, when the discharge amount of the exhaust gas from the gas discharge source is smaller than the discharge amount reference value set in advance, excessive charging in the wet-type electric dust collector 21 can be curbed at an appropriate timing by decreasing the charge output in the wet-type electric dust collector 21.
(6) The exhaust gas treatment system 10C according to a sixth aspect is the exhaust gas treatment system 10C according to any one of (1) to (5), in which the detection units 203 and 204 detect at least one of the concentration of volatile organic compounds in the exhaust gas and the concentration of the suspended particulate matter in the exhaust gas discharged from the absorption tower 12. The charge output adjustment unit 74C adjusts a charge output in the wet-type electric dust collector 21 on the basis of at least one of the concentration of the volatile organic compounds and the concentration of the suspended particulate matter detected by the detection units 203 and 204.

Accordingly, excessive charging in the wet-type electric dust collector 21 can be curbed by adjusting the charge output on the basis of at least one of the concentration of volatile organic compounds and the concentration of suspended particulate matter in exhaust gas discharged from the absorption tower 12.
(7) A dust collection device 20A according to a seventh aspect is provided in exhaust gas treatment systems 10A to 10C including a cooling tower 11 in which a cooling liquid is brought into contact with exhaust gas including carbon dioxide such that the exhaust gas is cooled; an absorption tower 12 into which an absorption liquid capable of absorbing carbon dioxide in the exhaust gas is introduced and in which the absorption liquid absorbs carbon dioxide in the exhaust gas that has gone through the cooling tower 11; and a regeneration tower 13 in which the absorption liquid that has absorbed carbon dioxide is heated, carbon dioxide is separated from the absorption liquid, and the absorption liquid is regenerated. The dust collection device 20A includes a wet-type electric dust collector 21 in which suspended particulate matter including sulfur trioxide included in the exhaust gas is charged such that the suspended particulate matter is captured; detection units 201 to 204 which detect at least one of the soot/dust concentration of the exhaust gas, the ozone concentration of the exhaust gas, the concentration of volatile organic compounds in the exhaust gas discharged from the absorption tower 12, and the concentration of the suspended particulate matter in the exhaust gas; and a control device 60A which controls a charge output in the wet-type electric dust collector 21. The control device 60A includes charge output adjustment units 74A to 74C which adjust a charge output in the wet-type electric dust collector 21 on the basis of at least one of the soot/dust concentration of the exhaust gas, the ozone concentration of the exhaust gas, the concentration of volatile organic compounds in the exhaust gas discharged from the absorption tower 12, and the concentration of the suspended particulate matter in the exhaust gas detected by the detection units 201 to 204.

In this dust collection device 20A, excessive charging in the wet-type electric dust collector 21 is curbed by adjusting the charge output in the wet-type electric dust collector 21 on the basis of at least one of the soot/dust concentration of the exhaust gas including carbon dioxide, the ozone concentration of the exhaust gas, the concentration of volatile organic compounds in the exhaust gas discharged from the absorption tower 12, and the concentration of the suspended particulate matter in the exhaust gas. Accordingly, an increase in suspended particulate matter of sulfur trioxide and an increase in ozone as a byproduct can be curbed, and therefore an adverse effect on the performance of exhaust gas treatment in the exhaust gas treatment systems 10A to 10C including the dust collection device 20A can be curbed.
(8) The control methods S10, S20, and S30 of the exhaust gas treatment systems 10A to 10C according to an eighth aspect are the control methods S10, S20, and S30 of the exhaust gas treatment systems 10A to 10C according to any one of (1) to (7) including Steps S11, S21, and S31 of acquiring information including at least one of the soot/dust concentration of the exhaust gas including carbon dioxide, the ozone concentration of the exhaust gas, the concentration of volatile organic compounds in the exhaust gas discharged from the absorption tower 12, and the concentration of the suspended particulate matter in the exhaust gas; and Steps S12, S22, and S32 of adjusting a charge output in the wet-type electric dust collector 21 on the basis of at least one of the soot/dust concentration of the exhaust gas, the ozone concentration of the exhaust gas, the concentration of volatile organic compounds in the exhaust gas discharged from the absorption tower 12, and the concentration of the suspended particulate matter in the exhaust gas.

In the control methods S10, S20, and S30 of these exhaust gas treatment systems 10A to 10C, excessive charging in the wet-type electric dust collector 21 is curbed by adjusting the charge output in the wet-type electric dust collector 21 on the basis of at least one of the soot/dust concentration of the exhaust gas, the ozone concentration of the exhaust gas, the concentration of volatile organic compounds in the exhaust gas discharged from the absorption tower 12, and the concentration of the suspended particulate matter in the exhaust gas. Accordingly, an increase in suspended particulate matter of sulfur trioxide and an increase in ozone as a byproduct can be curbed, and therefore an adverse effect on the performance of exhaust gas treatment can be curbed.
(9) The control methods S10, S20, and S30 of the exhaust gas treatment systems 10A to 10C according to a ninth aspect are the control methods S10, S20, and S30 of the exhaust gas treatment systems 10A to 10C according to (8), in which in Steps S12, S22, and S32 of adjusting the charge output, a charge output in the wet-type electric dust collector 21 is adjusted such that at least one of the soot/dust concentration of the exhaust gas and the ozone concentration of the exhaust gas becomes equal to or lower than a reference value set in advance on the basis of at least one of the soot/dust concentration of the exhaust gas and the ozone concentration of the exhaust gas detected, and correlation information related to a correlation between at least one of the soot/dust concentration of the exhaust gas and the ozone concentration of the exhaust gas and the charge output stored in advance.

Accordingly, the charge output can be easily controlled by adjusting the charge output in the wet-type electric dust collector 21 on the basis of at least one of the soot/dust concentration of the exhaust gas and the ozone concentration of the exhaust gas detected, and the correlation information stored in advance.
(10) The control methods S20 and S30 of the exhaust gas treatment systems 10B and 10C according to a tenth aspect are the control methods S20 and S30 of the exhaust gas treatment systems 10B and 10C according to (9), in which in Steps S22 and S32 of adjusting the charge output, when at least one of the soot/dust concentration of the exhaust gas and the ozone concentration of the exhaust gas detected deviates from the concentration range set in advance, a charge output in the wet-type electric dust collector 21 is adjusted to be within a charge output range set in advance.

Accordingly, when at least one of the soot/dust concentration of the exhaust gas and the ozone concentration of the exhaust gas deviates from the concentration range set in advance, excessive charging in the wet-type electric dust collector 21 can be curbed at an appropriate timing by adjusting the charge output to be within the charge output range set in advance.
(11) The control methods S20 and S30 of the exhaust gas treatment systems 10B and 10C according to an eleventh aspect are the control methods S20 and S30 of the exhaust gas treatment systems 10B and 10C according to any one of (8) to (10), in which in Steps S21 and S31 of acquiring the information, information related to a discharge amount of the exhaust gas from an external gas discharge source discharging the exhaust gas is further acquired. In Steps S22 and S32 of adjusting the charge output, a charge output in the wet-type electric dust collector 21 is adjusted on the basis of the information related to the discharge amount of the exhaust gas.

Accordingly, excessive charging in the wet-type electric dust collector 21 can be curbed with respect to the discharge amount of the exhaust gas by adjusting the charge output in the wet-type electric dust collector 21 in accordance with the discharge amount of the exhaust gas from the external gas discharge source.
(12) The control methods S20 and S30 of the exhaust gas treatment systems 10B and 10C according to a twelfth aspect are the control methods S20 and S30 of the exhaust gas treatment systems 10B and 10C according to (11), in which in Steps S22 and S32 of adjusting the charge output, when the discharge amount of the exhaust gas is smaller than a discharge amount reference value set in advance, a charge output in the wet-type electric dust collector 21 is decreased on the basis of the information related to the discharge amount of the exhaust gas.

Accordingly, when the discharge amount of the exhaust gas from the gas discharge source is smaller than the discharge amount reference value set in advance, excessive charging in the wet-type electric dust collector 21 can be curbed at an appropriate timing by decreasing the charge output in the wet-type electric dust collector 21.
(13) The control method S30 of the exhaust gas treatment system 10C according to a thirteenth aspect is the control method S30 of the exhaust gas treatment system 10C according to any one of (8) to (11), in which in Step S31 of acquiring the information, information including at least one of the concentration of volatile organic compounds in the exhaust gas discharged from the absorption tower 12 and the concentration of the suspended particulate matter in the exhaust gas is acquired. In Step S32 of adjusting the charge output, a charge output in the wet-type electric dust collector 21 is adjusted on the basis of at least one of the concentration of the volatile organic compounds and the concentration of the suspended particulate matter.

Accordingly, excessive charging in the wet-type electric dust collector 21 can be curbed by adjusting the charge output in the wet-type electric dust collector 21 on the basis of at least one of the concentration of volatile organic compounds and the concentration of suspended particulate matter in exhaust gas discharged from the absorption tower 12.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

10A to 10C exhaust gas treatment system
11 Cooling tower
11a Tower main body
11b Nozzle
12 Absorption tower
12a Tower main body
12b, 12c Nozzle
12d Washing water reservoir
12e Exhaust pipe
13 Regeneration tower
13a Tower main body
13b, 13c Nozzle
15 Collection unit
20A to 20C Dust collection device
21 Wet-type electric dust collector
31 Cooling liquid supply pump
32A first circulation pump
32B Second circulation pump
33 Absorption liquid circulation pump
41 First heat exchanger
43 Second heat exchanger
45 Heat exchanger
46 Third heat exchanger
48 Reboiler
49 Condenser
60A to 60C Control device
61 Processor
62 ROM
63 RAM
64 Storage
65 Signal transmission/reception module
70 Signal input unit
71 Information acquisition unit
72 Correlation information storage unit
73 External information acquisition unit
74A to 74C Charge output adjustment unit
75 Output unit
81 Steam supply pipe
82A to 82C Cooling water supply pipe
101 Gas introduction line
102 Cooling liquid supply line
103 Exhaust gas outlet line
105 Washing water circulation line
106 Circulation line
106A Absorption liquid supply line
106B Absorption liquid discharge line
107 Refrigerant line
108 Absorption liquid heating line
109 Gaseous carbon dioxide discharge line
110 Reflux line
111 Carbon dioxide discharge pipe
112 Reflux pump
201, 202 Detection unit
203, 204 Discharge concentration detection unit (detection unit)
L1 Cooling liquid
L2 Absorption liquid

1. An exhaust gas treatment system comprising:
a cooling tower in which a cooling liquid is brought into contact with exhaust gas including carbon dioxide such that the exhaust gas is cooled;
an absorption tower into which an absorption liquid capable of absorbing carbon dioxide in the exhaust gas is introduced and in which the absorption liquid absorbs carbon dioxide in the exhaust gas that has gone through the cooling tower;
a regeneration tower in which the absorption liquid that has absorbed carbon dioxide is heated, carbon dioxide is separated from the absorption liquid, and the absorption liquid is regenerated;
a wet-type electric dust collector in which suspended particulate matter including sulfur trioxide (SO₃) included in the exhaust gas is charged such that the suspended particulate matter is captured;
a detection unit which detects at least one of a soot/dust concentration of the exhaust gas, an ozone concentration of the exhaust gas, a concentration of volatile organic compounds (VOC) in the exhaust gas discharged from the absorption tower, and a concentration of the suspended particulate matter in the exhaust gas; and
a control device which controls a charge output in the wet-type electric dust collector, wherein
the control device includes a charge output adjustment unit which adjusts a charge output in the wet-type electric dust collector based on at least one of the soot/dust concentration of the exhaust gas, the ozone concentration of the exhaust gas, the concentration of volatile organic compounds in the exhaust gas discharged from the absorption tower, and the concentration of the suspended particulate matter in the exhaust gas detected by the detection unit.

2. The exhaust gas treatment system according to claim 1 further comprising:
a correlation information storage unit which stores correlation information related to a correlation between at least one of the soot/dust concentration of the exhaust gas and the ozone concentration of the exhaust gas and the charge output, wherein
the detection unit detects at least one of the soot/dust concentration of the exhaust gas and the ozone concentration of the exhaust gas, and
the control device adjusts a charge output in the wet-type electric dust collector such that at least one of the soot/dust concentration of the exhaust gas and the ozone concentration of the exhaust gas becomes equal to or lower than a reference value set in advance based on at least one of the soot/dust concentration of the exhaust gas and the ozone concentration of the exhaust gas detected by the detection unit, and the correlation information stored in the correlation information storage unit.

3. The exhaust gas treatment system according to claim 2, wherein when at least one of the soot/dust concentration of the exhaust gas and the ozone concentration of the exhaust gas detected by the detection unit deviates from a concentration range set in advance, the control device adjusts a charge output in the wet-type electric dust collector to be within a charge output range set in advance.

4. The exhaust gas treatment system according to claim 1, wherein
the control device further includes an external information acquisition unit which acquires information related to a discharge amount of the exhaust gas from an external gas discharge source discharging the exhaust gas, and
the charge output adjustment unit adjusts a charge output in the wet-type electric dust collector based on the information related to the discharge amount of the exhaust gas acquired by the external information acquisition unit.

5. The exhaust gas treatment system according to claim 4, wherein when the discharge amount of the exhaust gas is smaller than a discharge amount reference value set in advance, the control device decreases a charge output in the wet-type electric dust collector based on the information related to the discharge amount of the exhaust gas acquired by the external information acquisition unit.

6. The exhaust gas treatment system according to claim 1, wherein
the detection unit detects at least one of the concentration of volatile organic compounds in the exhaust gas and the concentration of the suspended particulate matter in the exhaust gas discharged from the absorption tower, and
the charge output adjustment unit adjusts a charge output in the wet-type electric dust collector based on at least one of the concentration of the volatile organic compounds and the concentration of the suspended particulate matter detected by the detection unit.

7. A dust collection device that is provided in an exhaust gas treatment system including a cooling tower in which a cooling liquid is brought into contact with exhaust gas including carbon dioxide such that the exhaust gas is cooled; an absorption tower into which an absorption liquid capable of absorbing carbon dioxide in the exhaust gas is introduced and in which the absorption liquid absorbs carbon dioxide in the exhaust gas that has gone through the cooling tower; and a regeneration tower in which the absorption liquid that has absorbed carbon dioxide is heated, carbon dioxide is separated from the absorption liquid, and the absorption liquid is regenerated, the dust collection device comprising:
a wet-type electric dust collector in which suspended particulate matter including sulfur trioxide included in the exhaust gas is charged such that the suspended particulate matter is captured;
a detection unit which detects at least one of a soot/dust concentration of the exhaust gas, an ozone concentration of the exhaust gas, a concentration of volatile organic compounds in the exhaust gas discharged from the absorption tower, and a concentration of the suspended particulate matter in the exhaust gas; and
a control device which controls a charge output in the wet-type electric dust collector, wherein the control device includes a charge output adjustment unit which adjusts a charge output in the wet-type electric dust collector based on at least one of the soot/dust concentration of the exhaust gas, the ozone concentration of the exhaust gas, the concentration of volatile organic compounds in the exhaust gas discharged from the absorption tower, and the concentration of the suspended particulate matter in the exhaust gas detected by the detection unit.

8. A control method of the exhaust gas treatment system according to claim 1, the control method comprising:
a step of acquiring information including at least one of a soot/dust concentration of the exhaust gas including carbon dioxide, an ozone concentration of the exhaust gas, a concentration of volatile organic compounds in the exhaust gas discharged from the absorption tower, and a concentration of the suspended particulate matter in the exhaust gas; and
a step of adjusting a charge output in the wet-type electric dust collector based on at least one of the soot/dust concentration of the exhaust gas, the ozone concentration of the exhaust gas, the concentration of volatile organic compounds in the exhaust gas discharged from the absorption tower, and the concentration of the suspended particulate matter in the exhaust gas.

9. The control method of the exhaust gas treatment system according to claim 8, wherein in the step of adjusting the charge output, a charge output in the wet-type electric dust collector is adjusted such that at least one of the soot/dust concentration of the exhaust gas and the ozone concentration of the exhaust gas becomes equal to or lower than a reference value set in advance based on at least one of the soot/dust concentration of the exhaust gas and the ozone concentration of the exhaust gas detected, and correlation information related to a correlation between at least one of the soot/dust concentration of the exhaust gas and the ozone concentration of the exhaust gas and the charge output stored in advance.

10. The control method of the exhaust gas treatment system according to claim 9, wherein in the step of adjusting the charge output, when at least one of the soot/dust concentration of the exhaust gas and the ozone concentration of the exhaust gas detected deviates from a concentration range set in advance, a charge output in the wet-type electric dust collector is adjusted to be within a charge output range set in advance.

11. The control method of the exhaust gas treatment system according to claim 8, wherein
in the step of acquiring the information, information related to a discharge amount of the exhaust gas from an external gas discharge source discharging the exhaust gas is further acquired, and
in the step of adjusting the charge output, a charge output in the wet-type electric dust collector is adjusted based on the information related to the discharge amount of the exhaust gas.

12. The control method of the exhaust gas treatment system according to claim 11, wherein in the step of adjusting the charge output, when the discharge amount of the exhaust gas is smaller than a discharge amount reference value set in advance, a charge output in the wet-type electric dust collector is decreased based on the information related to the discharge amount of the exhaust gas.

13. The control method of the exhaust gas treatment system according to claim 8, wherein
in the step of acquiring the information, information including at least one of the concentration of volatile organic compounds in the exhaust gas discharged from the absorption tower and the concentration of the suspended particulate matter in the exhaust gas is acquired, and
in the step of adjusting the charge output, a charge output in the wet-type electric dust collector is adjusted based on at least one of the concentration of the volatile organic compounds and the concentration of the suspended particulate matter.
